(19) United States
(12) Patent Application Publication
(10) Pub. No.: US 2009/0064551 A1
(43) Pub. Date: Mar. 12, 2009

(54) INFORMATION CARRIER

(76) Inventors: Erik Schroder, Goteborg (SE); Anders Nilsson, Goteborg (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 11/718,660

(22) PCT Filed: Nov. 7, 2005
(86) PCT No.: PCT/IB05/04123

§ 371 Date: May 4, 2007

Related U.S. Application Data
(60) Provisional application No. 60/627,042, filed on Nov. 12, 2004.

(51) Int. Cl. G09F 7/00

(52) U.S. Cl. 40/584

(57) ABSTRACT

The method facilitates for an individual to orientate himself in a building including the installation of at least an information carrier at a location selected with regard to a configuration of the building. The information carrier includes a visual representation of at least a section of a floor of the building and at least some information associated with the building. The visual representation is a perspective view of the section of the floor.

This application is based on U.S. Provisional Patent Application No. 60/627,042 filed on Nov. 12, 2004 and claims the benefit thereof for priority purposes.

### TECHNICAL FIELD

The present invention relates to an apparatus and method to facilitate an individual to make himself familiar in a building including placing at least one information carrier at a location selected with regard to the configuration of the building, wherein the information carrier includes a visual representation of at least a section of a floor of the building and at least some information connected thereto about the building.

An object of the invention is to place an information carrier in a suitable place, by means of which an individual, in case of fire or other emergency, more rapidly orientates himself in the area or in the building and finds evacuation routes, fire appliance and other equipment which can be used in case of emergency, such as alarm buttons, first aid equipment and the like than when regarding such a conventional signboard. This is achieved by the information carrier being arranged to be utilized in case of evacuation and including instructions concerning evacuation routes.

Another object of the invention is to place the information carrier in a suitable way where an individual perceives significant information about the configuration of the area or the building. Yet another object of the invention is to place an information carrier, which increases the possibility for the individual to remember more information during a longer period of time than looking at a conventional signboard. This may be achieved by a method of the invention to arrange an information carrier including symbols for indication of means to be used in an emergency case, such as alarm, fire appliance and/or first aid equipment.

According to another object of the invention said information carrier may be arranged to describe the contents of different rooms/departments of a building. In a similar way, the information carrier may be used to describe a delimited area outdoors, e.g. a playground, a block, a park or the like, which is achieved by an information carrier including a description of the different rooms/departments of the building/area.

### BRIEF DESCRIPTION OF THE DRAWINGS

FIG. 1 shows a conventional two-dimensional evacuation plan;

FIG. 2a shows an evacuation plan according to the principles of the invention, configured for a first location in a building;

FIG. 2b shows an evacuation plan according to the principles of the invention, configured for a second location in a building;

FIG. 3 shows a perception diagram; and

FIG. 4 shows a memory diagram.

### DESCRIPTION OF THE INVENTION

According to regulations known, it is required that public buildings, working sites, or other public institutions are provided with evacuation plans and information boards about where to find evacuation routes, emergency exits and equipment to be used in case of emergency, e.g. fire appliance, alarms, first aid equipment and the like.

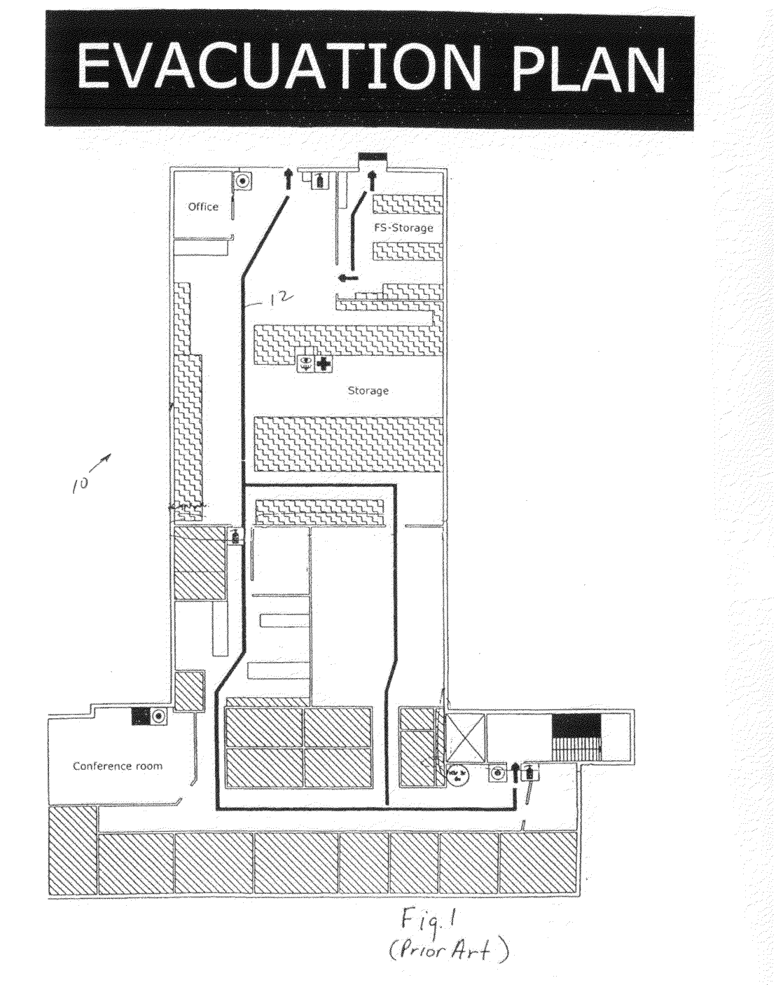

Conventional evacuation plans typically include a planar (two-dimensional) aerial view of a present area in a building. An example of such an evacuation plan is shown, generally indicated at 10, in FIG. 1. Evacuation routes are indicated by lines 12.

The invention is based on the fact that we all have different spatial ability. To perceive how different rooms are placed in relation to each other and in an overstrained situation to be able to orientate oneself according to that plan is of vital importance for the evacuation. It is also important that an individual, in other situations, can rapidly and simply translate the information given about a building or an area, for example, to be informed about the content of different departments.

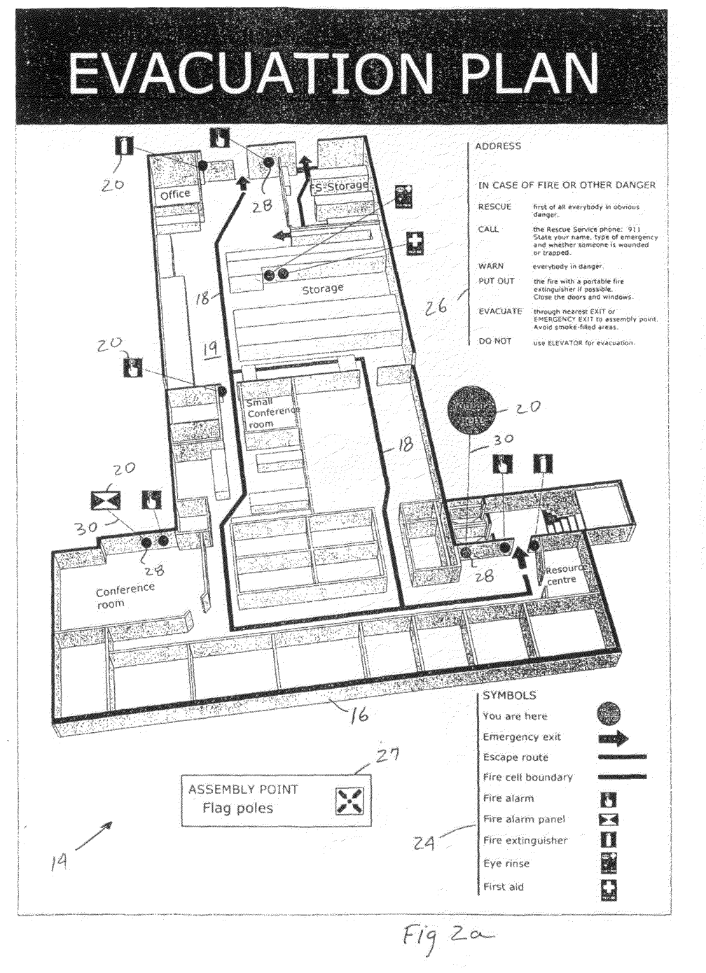

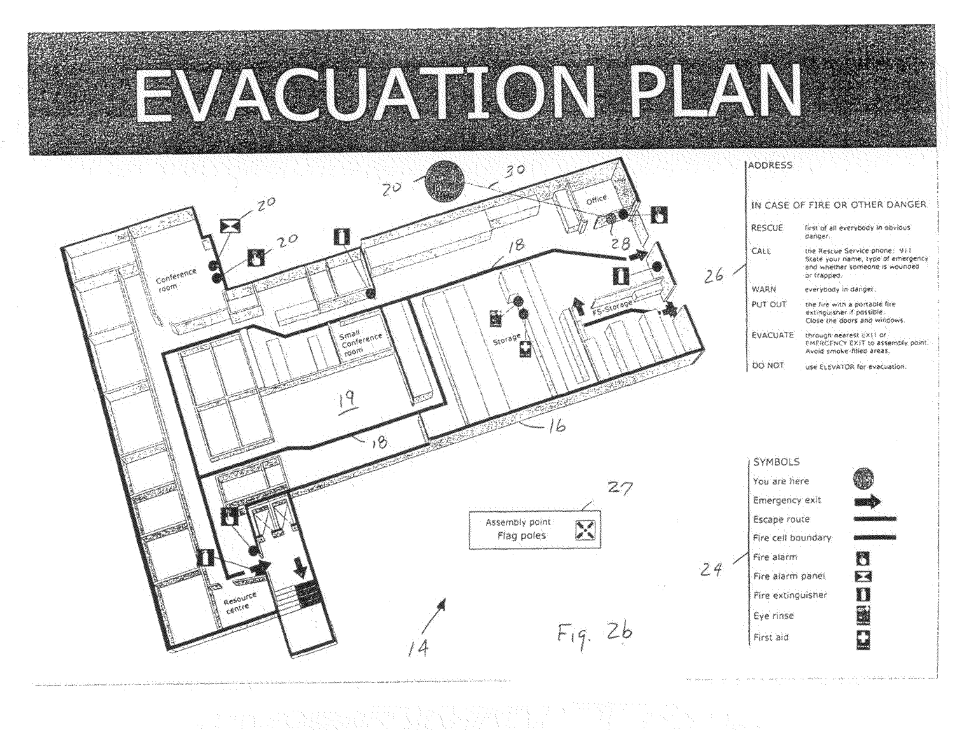

An evacuation plan, generally indicated at 14 in accordance with the invention, is shown in FIGS. 2a and 2b. The plan 14 includes, in a preferred embodiment, a 3-dimensional drawing 14, where the perspective is based on the viewer's unique location. The 3-dimensional floor plan 16 is adapted to the specific location of the evacuation plan. Consequently, a plurality of plans is provided such as in a kit for a single building floor. Each evacuation plan 14 of the kit is placed at a specific location on a wall of a building floor and shows a characteristic 3-dimensional floor plan drawing with a view that substantially corresponds to the specific location. Thus, one evacuation plan 14 placed at a first location of a building floor differs from another evacuation plan 14 placed at a second location on the same building floor. This is evident from FIGS. 2a and 2b. Exit pathways are preferably indicated by green lines 18 and arrows provided on a yellow walkway 19 of the floor plan of the building. These colors have been selected since they have been determined to facilitate visual awareness and ease of recognition by the viewer.

The evacuation plan 14 includes symbols 20 and a symbol chart 24 that describes the symbols 20. Also, building information 26 can be provided on the evacuation plan 14. This information can include emergency telephone numbers, evacuation instructions, fire boundary locations, and/or the location of outside assembly points as indicated at 27.

Preferably, the symbols 20 are spread and placed so that they do not intrude on the 3-dimensional floor plan 16 drawing 10 itself. The actual location of the equipment in the facility is instead marked with a dot 28 and is color-coded as follows:
1. Red dot for fire appliance (fire extinguisher)
2. Green dot for first aid equipment
3. Orange dot for the location of the 3-dimensional evacuation plan (You are here).

A respective dot 28 is associated with a line 30 linked to the proper symbol 20. Colors and symbols are adapted so that they coincide with existing displaying, which further enhances the feeling to know where you stand. The symbols 20 are adapted to the actual symbols used in the building or at that area.

The 3-dimensional floor plan 16 can be used for buildings such as office buildings (FIG. 2a, 2b) or for other buildings such as hotels, schools, sports arenas, factories, etc.

### Performed Experiments

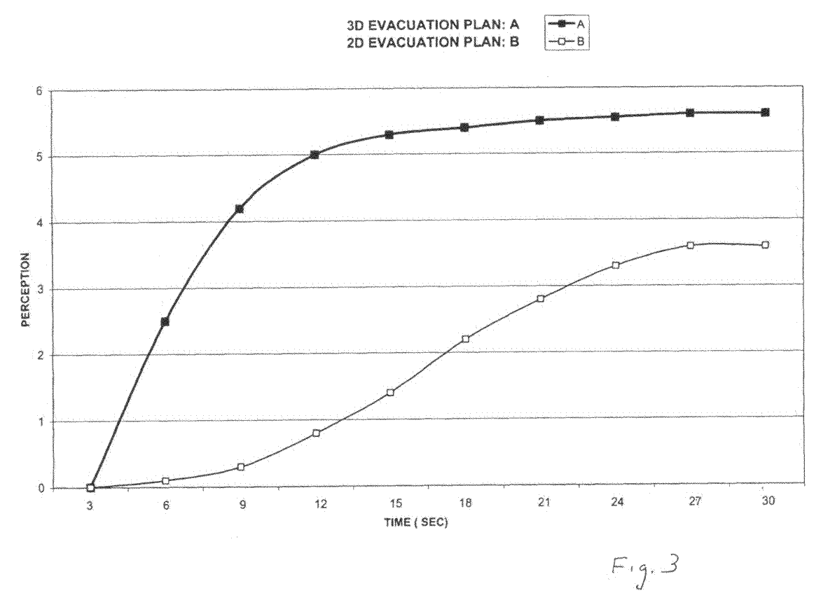

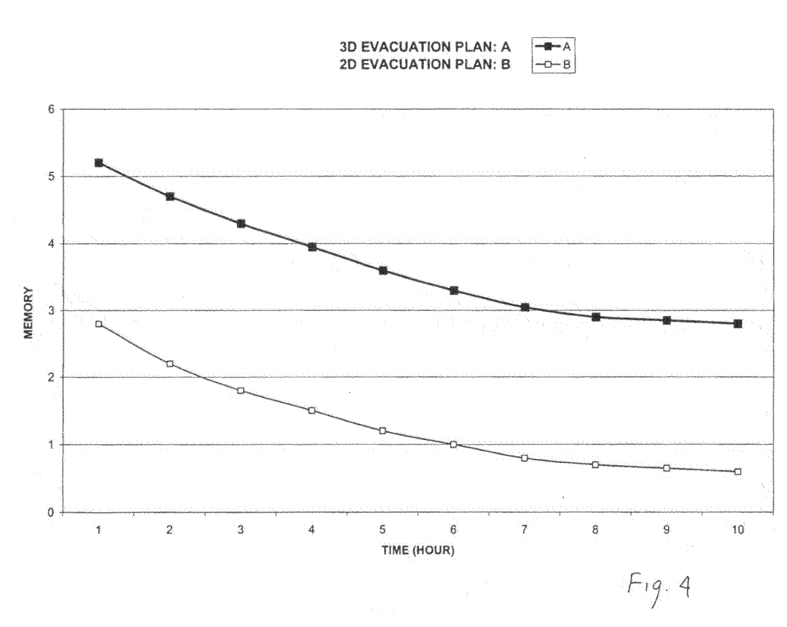

During practical experiments, a comparison was made how rapid and with which wealth of details an individual perceives a 3-dimensional floor plan drawing 16 of an evacuation plan versus a conventional 2-dimensional drawing of a floor plan. A number of persons studied a 3-dimensional floor plan drawing 16 of a premises in which a number of details were marked (totally 6). During the experiments, it was examined how much time the persons needed to orientate themselves with guidance of the respective drawing and also how many of the marked details which they could report. The result of this examination is shown in the diagram in FIG. 3, from which you can see how rapid (x-axis) and at which wealth of details (y-axis) an individual interprets a 3-dimensional evacuation plan according to the invention compared with a corresponding 2-dimensional conventional evacuation plan. As can be seen from the diagram, the 3-dimensional plan reduces the time consumption for the interpretation of the evacuation plan as well as of its information by more than 3.5 times. This implies that instead of studying a 2-dimensional evacuation plan for 30 seconds, only 8 seconds are needed for a 3-dimensional evacuation plan. Further, the test persons remember details during a longer period of time and with greater precision by studying the 3-dimensional plan for the considerably shorter time period, which can be seen from the diagram in FIG. 4.

The invention shows that persons interpret a 3-dimensional floor plan drawing 16, i.e. a perspective view of premises on an evacuation plan, more rapidly and perceives more details than if the corresponding evacuation plan comprises a conventional 2-dimensional planar aerial view. With a 3-dimensional evacuation plan according to the invention, persons can use the information more simply according to their own estimates. By adapting the 3-dimensional drawing on each separate evacuation plan in accordance with the specific location of the viewer additional advantages are obtained. Another aspect in this context is that children and youth spend long periods in front of computers and video games and are used to interpreting information presented in the 3-dimensional form, which increases their possibilities to interpret the evacuation plan rapidly.

According to the examination, the invention shows the following advantages:
The starting point (You are here) is found more easily
The 3-dimensional drawing is perceived in a more natural way than the 2-dimensional drawing, and therefore the 3-dimensional plan is more easily and more rapidly translated to the reality
The building/area and its limitations are interpreted more rapidly
Conclusions are made which better correspond to the reality
It is easier to memory and remember during a longer period of time
It is better and easier for people to transfer the information to reality based on the 3-dimensional plan, e.g. fireplugs, evacuation routes, rest rooms, etc.

In summary, the evacuation plan 14 results in that people better remember and quicker and easier find the intended destination. This implies that the evacuation time or the time to find, for example, the fire extinguisher is reduced considerably. With the evacuation plan of the invention an evacuation plan is offered, which demonstrably is easier for people to perceive and to translate to reality. We have then increased the person's perception per time unit.

Within the concept of the invention other information carriers than those presented in the figures can be used. The information carrier can include a Projector, TV-screen, projector or computer monitor. An information carrier comprising a 3-dimensional plan visualised by holography is another example.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

1. A method to facilitate an individual to orientate oneself in a building including the steps of: providing at least one information carrier including a visual representation of at least a section of a building floor and information associated with the buildings wherein the visual representation is a perspective view of the section of the building floor, and installing the at least one information carrier at a location selected with regard to a configuration of the building and that substantially corresponds to the visual representation.

2. The method according to claim 1, wherein the perspective view corresponds to a specific location of the building floor.

3. The method according to claim 1, wherein the information carrier is arranged to be used upon evacuation and the information includes instructions about evacuation routes for the building floor and an indication of a present location of a user on the building floor as the user is viewing the information carrier.

4. The method according to claim 3, wherein the providing step further includes providing symbols indicating a location of equipment to be used in emergency situations.

5. The method according to claim 4, wherein the symbols indicate the location of at least one of alarms, fire appliance and first aid equipment.

6. The method according to claim 5, wherein the symbols are color-coded.

7. The method according to claim 6, wherein an actual location of a symbol is indicated by an associated dot and the symbols are placed outside of the bounds of the section of the building floor so as to not obstruct the section, with a line lining the symbol with the associated dot.

8. The method according to claim 7, wherein the information carrier includes a description of different rooms of the floor of the building.

9. A method to facilitate an individual to orientate oneself in a building including the steps of: providing a plurality of information carriers, each information carrier including a visual representation of at least a specific section of a building floor and information associated with the building, wherein each visual representation is different from another and each visual representation is a perspective view of the specific section of the building floor, and installing each information carrier at a location on the building floor that substantially corresponds to the visual representation.

10. The method according to claim 9, wherein each information carrier is arranged to be used upon evacuation and the information includes instructions about evacuation routes for the building floor and an indication of a present location of a user on the building floor as the user is viewing the information carrier.

11. The method according to claim 9, wherein the providing step further includes providing symbols indicating a location of equipment to be used in emergency situations.

12. The method according to claim 11, wherein the symbols indicate the location of at least one of alarms, fire appliance and first aid equipment.

13. The method according to claim 12, wherein the symbols are color-coded.

14. The method according to claim 13, wherein an actual location of a symbol is indicated by an associated dot and the symbols are placed outside of the bounds of the section of the building floor so as to not obstruct the section, with a line linking the symbol and the associated dot.

15. An emergency evacuation kit for a building, the kit comprising: a plurality of information carriers, each information carrier including a visual representation of at least a specific section of a building floor, wherein the visual representation is a perspective view of the specific section of the building floor, each visual representation being different from another and each information carrier being constructed and arranged to be mounted at a location on the building floor that substantially corresponds to the visual representation.

16. The kit according to claim 15, wherein each information carrier is arranged to be used upon evacuation and the information includes instructions about evacuation routes for the building floor and an indication of a present location of a user on the building floor as the user is viewing the information carrier.

17. The kit according to claim 15, wherein each information carrier further includes symbols indicating a location of equipment to be used in emergency situations.

18. The kit according to claim 17, wherein the symbols indicate the location of at least one of alarms, fire appliance and first aid equipment.

19. The kit according to claim 18, wherein the symbols are color-coded.

20. The method according to claim 18, wherein an actual location of a symbol is indicated by an associated dot and the symbols are placed outside of the bounds of the section of the building floor so as to not obstruct the section, with a line lining the symbol with the associated dot.

21. The kit according to claim 18, wherein a walkway of the building floor of each information carrier is yellow in color and the instructions about evacuation routes are lines and arrows, disposed on the walkway, that are green in color.
